(19) United States
(12) Patent Application Publication
(10) Pub. No.: US 2019/0286702 A1
(43) Pub. Date: Sep. 19, 2019

(54) DISPLAY CONTROL APPARATUS, DISPLAY CONTROL METHOD, AND COMPUTER-READABLE RECORDING MEDIUM

(71) Applicant: FUJITSU LIMITED, Kawasaki-shi (JP)

(72) Inventors: Masahiro Kataoka, Kamakura (JP); Shouji Iwamoto, Yamato (JP); Takako Yamaguchi, Yokohama (JP)

(73) Assignee: FUJITSU LIMITED, Kawasaki-shi (JP)

(21) Appl. No.: 16/284,136

(22) Filed: Feb. 25, 2019

(30) Foreign Application Priority Data
Mar. 13, 2018 (JP) 2018-045893

(51) Int. Cl. G06F 17/27

(52) U.S. Cl. CPC G06F 17/2785

(57) ABSTRACT

A non-transitory computer-readable recording medium stores therein a display control program that causes a computer to execute a process including: determining, when an operation for converting a piece of text data is received, whether the piece of text data includes a word text corresponding to a plurality of words with different meanings; acquiring, when the word text is included, a confirmed text already having a conversion result confirmed before the operation is received, by referring to a first storage that stores therein confirmed texts already having conversion results confirmed, referring to a second storage that stores therein pieces of co-occurrence information of texts with respect to each of the words in a manner mapped to the word, and determining an order in which the words are displayed among the pieces of co-occurrence information; and displaying the words in the determined order for displaying, in a selectable manner as conversion candidates.

### CROSS-REFERENCE TO RELATED APPLICATION

This application is based upon and claims the benefit of priority of the prior Japanese Patent Application No. 2018-045893, filed on Mar. 13, 2018, the entire contents of which are incorporated herein by reference.

### FIELD

The embodiment discussed herein is related to a computer-readable recording medium and the like.

### BACKGROUND

For kana-to-kanji conversions, a begins-with match index is appended to each word in a word dictionary. Inputting operations are then assisted by displaying kanji words that are the candidates of a kana-to-kanji conversion based on a head kana character of a character string having been entered, or based on a head kanji character of a character string having its conversion result already confirmed. For each of such candidate kanji words to which kana characters can be converted, a score is calculated based on the word hidden Markov model (HMM) or the conditional random field (CRF), for example (see Japanese Laid-open Patent Publication No. 2005-309706 and Japanese Laid-open Patent Publication No. 10-269208, for example), and the candidates are displayed in the descending order of the scores. The word HMM stores therein a word in a manner mapped to a piece of information representing a co-occurrence of the word with another, for example.

### SUMMARY

According to an aspect of an embodiment, a non-transitory computer-readable recording medium stores therein a display control program that causes a computer to execute a process including: determining, when an operation for converting a piece of text data is received, whether the piece of text data includes a word text corresponding to a plurality of words with different meanings; acquiring, when the word text is included, a confirmed text already having a conversion result confirmed before the operation is received, by referring to a first storage that stores therein confirmed texts already having conversion results confirmed, referring to a second storage that stores therein pieces of co-occurrence information of texts with respect to each of the words in a manner mapped to the word, and determining an order in which the words are displayed based on a piece of co-occurrence information of a text having some association with the acquired confirmed text, among the pieces of co-occurrence information of the texts; and displaying the words in the determined order for displaying, in a selectable manner as conversion candidates.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic for explaining an example of a process performed by an information processing apparatus according to an embodiment;

FIG. 2 is a functional block diagram illustrating a configuration of the information processing apparatus according to the embodiment;

FIG. 3 is a schematic illustrating an exemplary data structure of dictionary data;

FIG. 4 is a schematic illustrating an exemplary data structure of a sentence HMM;

FIG. 5 is a schematic illustrating an exemplary data structure of sequence data;

FIG. 6 is a schematic illustrating an exemplary data structure of an offset table;

FIG. 7 is a schematic illustrating an exemplary data structure of an index;

FIG. 8 is a schematic illustrating an exemplary data structure of a high-level index;

FIG. 9 is a schematic for explaining hashing of an index;

FIG. 10 is a schematic illustrating an exemplary data structure of index data;

FIG. 11 is a schematic for explaining an example of a process of unhashing a hashed index;

FIG. 12 is a schematic for explaining an example of a process of extracting a word candidate;

FIG. 13 is a schematic for explaining an example of a process of calculating a sentence vector;

FIG. 14 is a schematic for explaining an example of a process of presuming a word;

FIG. 15 is a flowchart illustrating the sequence of a process performed by a sentence HMM generating unit;

FIG. 16 is a flowchart illustrating the sequence of a process performed by an index generating unit;

FIG. 17 is a flowchart illustrating the sequence of a process performed by a word candidate extracting unit;

FIG. 18 is a flowchart illustrating the sequence of a process performed by a word presuming unit; and

FIG. 19 is a schematic illustrating an exemplary hardware configuration of a computer implementing the same functions as those of the information processing apparatus.

### DESCRIPTION OF EMBODIMENT

However, in the related technology described above, when a text is divided into a plurality of sentences, nouns appearing repeatedly are replaced with pronouns, and the order in which kanji candidates are displayed becomes less accurate, disadvantageously.

In the related technology, because there are a plurality of kanji candidates that correspond to words with the same pronunciation (homonyms), the candidates are sorted and displayed by scores based on the word HMM. However, if a text is divided into a plurality of sentences, and a word co-occurring with a homonym is replaced with a pronoun, it is no longer possible to calculate the scores of the conversion candidates accurately based on the word HMM. Therefore, even if the scores are calculated based on the word HMM, the order in which the conversion candidates are displayed may be no longer quite accurate.

Preferred embodiments will be explained with reference to accompanying drawings. This embodiment is, however, not intended to limit the scope of the present invention in any way.

Display Control Process According to Embodiment

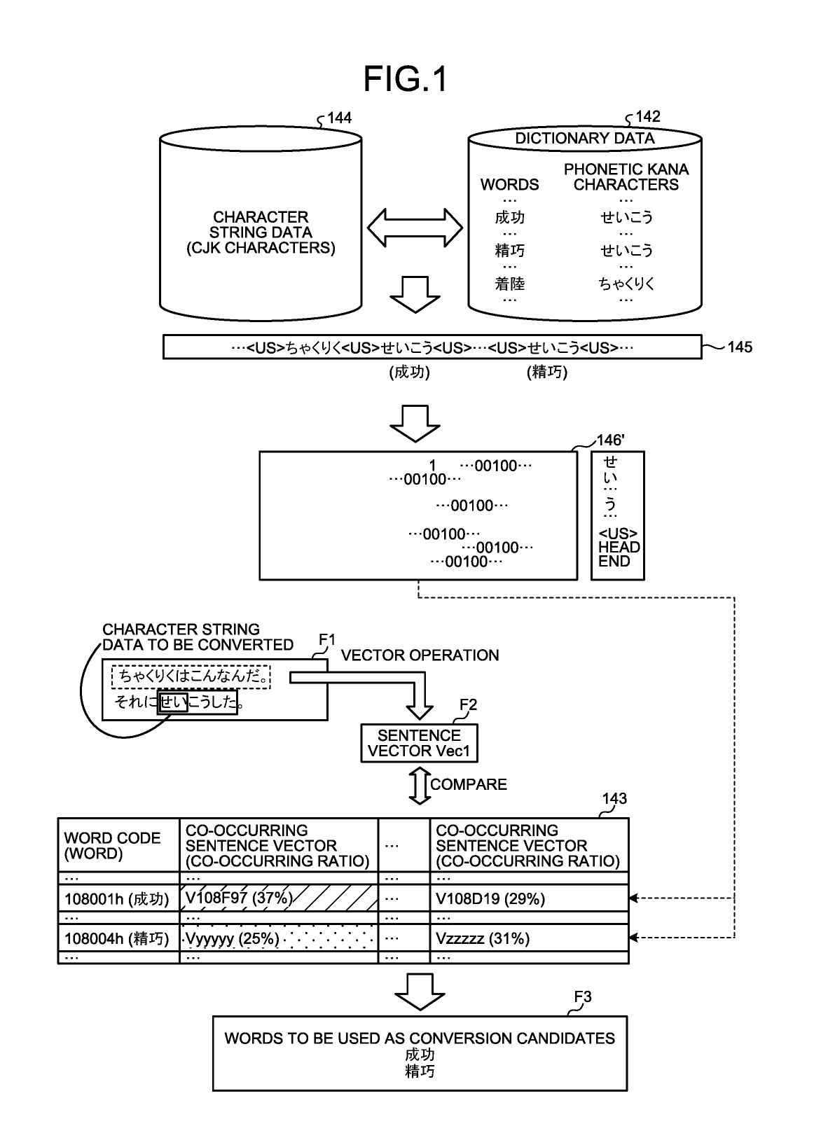

FIG. 1 is a schematic for explaining an example of a process performed by an information processing apparatus according to the embodiment. As illustrated in FIG. 1, if a piece of character string data F1 to be kana-to-kanji converted is received, and if the character string data F1 includes a character string corresponding to a plurality of homonym words, this information processing apparatus determines the order for displaying a plurality of words F3 that are candidates to which the character string can be converted, based on a sentence having the conversion result already confirmed, and on sentence HMM data 143. The information processing apparatus then displays the words F3 that are the conversion candidates in the determined order for displaying such words, in a selectable manner. The character string data F1 to be converted corresponds to Japanese characters, but may also correspond to Chinese or Korean characters, without limitation to the Japanese characters. In the embodiment, the character string data F1 will be explained as Japanese hiragana.

Explained to begin with is a process in which the information processing apparatus generates an index 146′ from character string data 144.

For example, the information processing apparatus compares the character string data 144 with dictionary data 142. The dictionary data 142 is data defining the words (morphemes) to be used as kana-to-kanji conversion candidates. The dictionary data 142 serves as dictionary data used in morphological analyses, and also as dictionary data used in kana-to-kanji conversions. The dictionary data 142 includes homonyms, which have the same pronunciations but different meanings.

The information processing apparatus scans the character string data 144 from its head, extracts a character string that matches a word that is defined in the dictionary data 142, and stores the extracted character string in sequence data 145.

The sequence data 145 contains, among the character strings included in the character string data 144, the words defined in the dictionary data 142, with a <unit separator (US)> registered at each break therebetween. For example, assuming that the information processing apparatus finds matches for the words “ [symbol] (“landing” in Japanese)”, “ [symbol] (“success” in Japanese)“, . . . “ [symbol] ” (“sophistication” in Japanese)” as being registered in the dictionary data 142, as a result of comparing the character string data 144 with the dictionary data 142, the information processing apparatus stores the phonetic kana characters representing the matched words in the sequence data 145, as illustrated in FIG. 1. In this example, “ [symbol] ” and “ [symbol] [symbol] ” are homonyms.

After generating the sequence data 145, the information processing apparatus generates an index 146′ corresponding to the sequence data 145. The index 146′ is information in which each of the characters is mapped to an offset. An offset represents the position of the character in the sequence data 145. For example, if a character “ [symbol] ” is found as the n₁^{th} character from the head in the sequence data 145, a flag “1” is set to the position of the offset n₁ in a row (bitmap) that corresponds to the character “ [symbol] ” in the index 146′.

The index 146′ according to the embodiment also maps the positions of the “head” and the “end” of a word, and the position of <US> to the offsets. For example, a character “ [symbol] ” is at the head of the word “ [symbol] ”, and a character “ [symbol] ” is at the end. If the character “ [symbol] ” at the head of the word “ [symbol] ” is found as the n₂^{th} character from the head in the sequence data 145, a flag “1” is set to the position of the offset n₂ in a row that corresponds to the HEAD, in the index 146′. If the character “ [symbol] ” that is at the end of the word “ [symbol] ” is found as the n₃^{th} character from the head in the sequence data 145, a flag “1” is set to the position of the offset n₃ in a row corresponding to the “END”, in the index 146′.

If a “<US>” is found as the n₄^{th} character from the head in the sequence data 145, a flag “1” is set to the position of the offset n₄ in a row that corresponds to “<US>” in the index 146′.

By referring to the index 146′, the information processing apparatus can recognize the positions of the characters making up a word that is included in the character string data 144, and the positions of the head and the end of the characters, and the position of a word break (<US>). Furthermore, a string of characters between the HEAD and the END in the index 146′ can be said to be a word to be used as a kana-to-kanji conversion candidate. In the explanation hereunder, a kana-to-kanji conversion candidate is sometimes simply referred to as a “conversion candidate”.

It is assumed now that the information processing apparatus receives an operation for converting a new piece of character string data F1 after receiving an operation for confirming the conversion result of another character or character string. It is also assumed herein that the character string data F1 to be converted is “ [symbol] ”, as an example.

The information processing apparatus then determines whether the character string data F1 to be converted includes any character string corresponding to a plurality of homonym words.

For example, the information processing apparatus extracts words that are the conversion candidates corresponding to “ [symbol] ” that is included in the character string data F1 to be converted “ [symbol] ”, from the index 146′, the sequence data 145, and the dictionary data 142. As an example, the information processing apparatus refers to the index 146′, and retrieves the position of “ [symbol] ”, which is included in the character string data F1 to be converted, from the sequence data 145. The information processing apparatus then extracts the words specified at the retrieved positions from the sequence data 145 and the dictionary data 142. It is assumed herein that “ [symbol] ” and “ [symbol] ” are extracted as words to be used as the conversion candidates. Because the extracted words, which are the conversion candidates, have the same phonetic kana characters but different meanings, the information processing apparatus determines that the extracted words to be used as the conversion candidates are homonyms. In other words, the information processing apparatus determines that the character string data F1 to be converted “ [symbol] ” includes a character string “ [symbol] ” corresponding to homonym words that are “ [symbol] ” and “ [symbol] ”.

If the character string data F1 to be converted includes a character string corresponding to homonym words, the information processing apparatus acquires a sentence having some association with the character string data F1 to be converted, from the sentences or the texts having the conversion results already confirmed. Such a sentence may be any sentence associated with the character string data F1 that is to be converted. For example, such a sentence may be a sentence immediately previous to the character string data F1 to be retrieved. As an example, assuming that the entire character string data to be converted is “ [symbol] [symbol] [symbol] ”, a sentence “ [symbol] [symbol] ” is acquired, as a sentence that is immediately previous to “ [symbol] ” that is the current character string data F1 to be converted.

The information processing apparatus then calculates a sentence vector of the acquired sentence. To calculate a sentence vector, the information processing apparatus calculates the word vectors of words included in the sentence based on the Word2Vec technology, and calculates the sentence vector by integrating the word vectors of such words. The Word2Vec technology is configured to perform a process of calculating a vector of each word, based on the relation between the word and another word adjacent thereto. The information processing apparatus generates vector data F2 by performing the process described above.

The information processing apparatus then refers to sentence hidden-Markov model (HMM) data 143, and determines the order in which the words of the conversion candidates are displayed based on co-occurrence information of sentence vectors of sentences having some association with the sentence vector of the acquired sentence.

In this example, the sentence HMM data 143 maps a word to a plurality of co-occurring sentence vectors. A word in the sentence HMM data 143 is a word registered in the dictionary data 142. The co-occurring sentence vector is a sentence vector obtained from a sentence co-occurring with the word.

A co-occurring sentence vector is mapped with a co-occurring ratio. For example, if a character string included in the character string data F1 to be converted indicates a word “ [symbol] ”, the sentence HMM data 143 indicates, for sentences co-occurring with this word, that the probability of the sentence vector being “V108F97” is “37 percent”, and that the probability of the sentence vector being “V108D19” is “29 percent”.

For example, the information processing apparatus compares the sentence vector represented by the vector data F2 with the co-occurring sentence vectors that are associated with each of the words of the conversion candidates in the sentence HMM data 143, and identifies the co-occurring sentence vectors that match or are similar to the sentence vector. The information processing apparatus then calculates a score for each permutation of the words to be used as the conversion candidates, using the co-occurring ratios of the identified co-occurring sentence vectors. The information processing apparatus determines the order of the words in the permutation resulted in the highest score as the order in which such words are displayed. As an example, it is assumed that the sentence vector represented by the vector data F2 matches or is similar to a co-occurring sentence vector “V0108F97”, which corresponds to “ [symbol] ”. It is also assumed that the sentence vector represented by the vector data F2 also matches or is similar to the co-occurring sentence vector “Vyyyyy”, which corresponds to “ [symbol] ”. If the calculation of the score for the permutation “ [symbol] ” and “ [symbol] ” is higher than that of the permutation “ [symbol] ” and “ [symbol] ”, the information processing apparatus determines the order of the permutation “ [symbol] ” and “ [symbol] ” resulted in a higher score as the order in which these words are displayed.

The information processing apparatus then displays the words in the determined order for displaying, as the words of conversion candidates, in a selectable manner (reference numeral F3).

As described above, the information processing apparatus determines the order in which a plurality of kanji characters that are conversion candidates are displayed, based on the co-occurrence between the sentence HMM data 143 and a sentence having some association with the character string data F1 currently being kana-to-kanji converted, among the sentences having the conversion results already confirmed. In this manner, the information processing apparatus can display a plurality of kanji characters that are conversion candidates based on the likeliness of the kanji characters being selected.

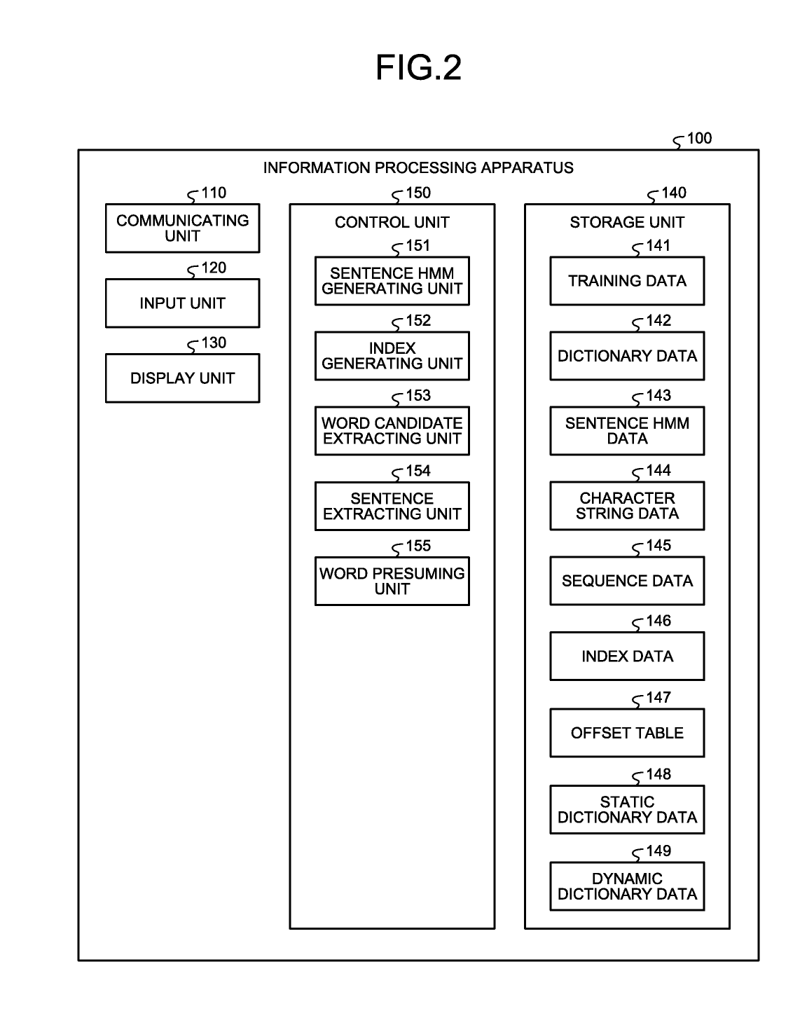

FIG. 2 is a functional block diagram illustrating a configuration of the information processing apparatus according to the embodiment. As illustrated in FIG. 2, this information processing apparatus 100 includes a communicating unit 110, an input unit 120, a display unit 130, a storage unit 140, and a control unit 150. The information processing apparatus 100 is an example of a display control apparatus.

The communicating unit 110 is a processing unit that communicates with another external device over a network. The communicating unit 110 corresponds to a communication device. For example, the communicating unit 110 may receive the dictionary data 142, the character string data 144, training data 141, and the like from an external device, and store such data in the storage unit 140.

The input unit 120 is an input device for inputting various types of information to the information processing apparatus 100. For example, the input unit 120 corresponds to a keyboard, a mouse, and a touch panel.

The display unit 130 is a display device for displaying various types of information output from the control unit 150. For example, the display unit 130 corresponds to a liquid crystal display or a touch panel.

The storage unit 140 has the training data 141, the dictionary data 142, the sentence HMM data 143, the character string data 144, the sequence data 145, index data 146, an offset table 147, static dictionary data 148, and dynamic dictionary data 149. The storage unit 140 corresponds to a semiconductor memory device such as a flash memory, or a storage device such as a hard disk drive (HDD).

The training data 141 is data representing an enormous number of natural sentences including homonyms, for improving the accuracy of kana-to-kanji conversions. For example, the training data 141 may be data including an enormous number of natural sentences such as a corpus.

The dictionary data 142 is information that defines Chinese, Japanese, and Korean (CJK) words to be used as word candidates to which an entry can be kana-to-kanji converted. In this example, noun CJK words are used as an example, but the dictionary data 142 also includes CJK words such as adjectives, verbs, and adverbs. For the verbs, inflections of the verbs are also defined. In the explanation herein, the dictionary data 142 is used in kana-to-kanji conversions, but may also be used in morphological analyses.

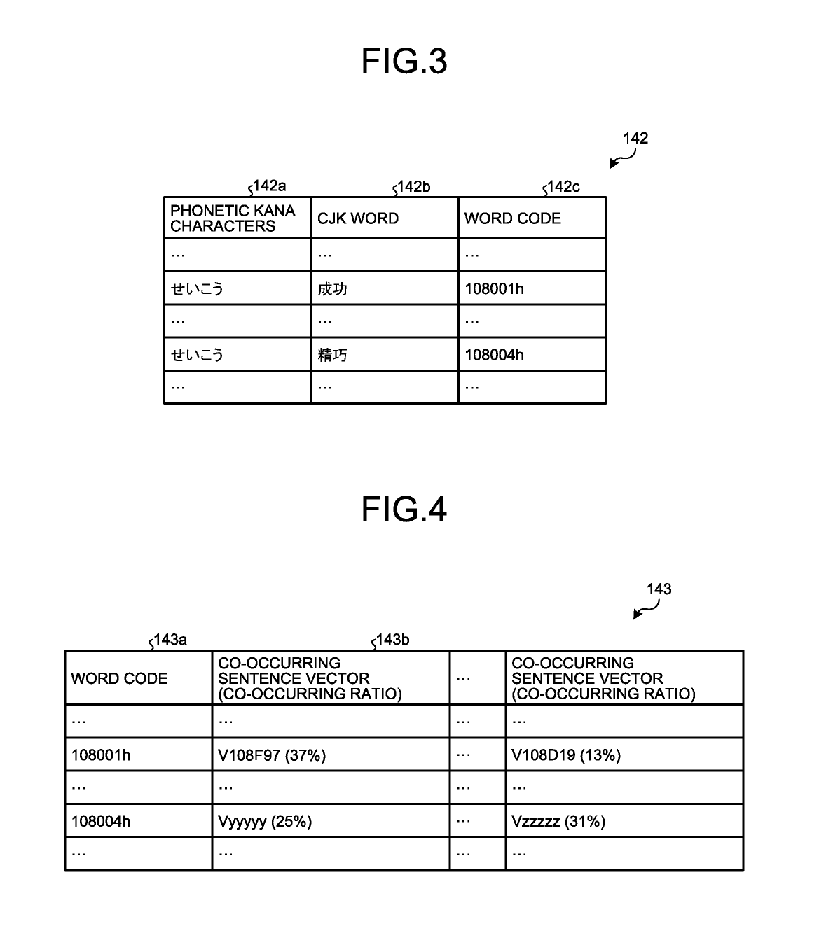

FIG. 3 is a schematic illustrating an exemplary data structure of the dictionary data. As illustrated in FIG. 3, the dictionary data 142 stores therein phonetic kana characters 142a, a CJK word 142b, and a word code 142c in a manner mapped to one another. The phonetic kana characters 142a are phonetics kana characters of the corresponding CJK word 142b. The word code 142c is a code resultant of encoding the CJK word, and uniquely representing the CJK word, unlike the character code sequence of the CJK word. For example, as the word code 142c, CJK words appearing more frequently in the text data are assigned with shorter codes, based on the training data 141. The dictionary data 142 is generated in advance.

Referring back to FIG. 2, the sentence HMM data 143 is information that maps sentences to a word.

FIG. 4 is a schematic illustrating an exemplary data structure of the sentence HMM. As illustrated in FIG. 4, the sentence HMM data 143 stores therein a word code 143a that identifies a word, and a plurality of co-occurring sentence vectors 143b, in a manner mapped to each other. The word code 143a is a code that identifies a word registered in the dictionary data 142. The co-occurring sentence vector 143b is mapped with a co-occurring ratio. The co-occurring sentence vector 143b is a vector that is obtained from a sentence that co-occurs with the word corresponding to the word code 143a. The co-occurring ratio indicates the probability at which the word corresponding to the word code 143a co-occurs with a sentence represented by a piece of co-occurring sentence vector 143b. In other words, the co-occurring ratio can be said to be a probability at which the word corresponding to the word code 143a co-occurs with a sentence having some association with the character string to be converted. For example, FIG. 4 illustrates, assuming that a word included in a character string to be converted is assigned with a word code “108001h”, that chances at which the sentence (the sentence with a sentence vector “V108F97”) co-occurs with a sentence having some association with the character string to be converted is “37 percent”. The sentence HMM data 143 is generated by a sentence HMM generating unit 151, which will be described later.

Referring back to FIG. 2, the character string data 144 is a piece of text data to be processed. For example, the character string data 144 is described in CJK characters. As an example, “ . . . [symbol] [symbol] . . . ” is described in the character string data 144.

The sequence data 145 contains phonetic kana characters of the CJK words defined in the dictionary data 142, among the character strings included in the character string data 144. In the description hereunder, the phonetic kana characters of a CJK word is sometimes simply referred to as a word.

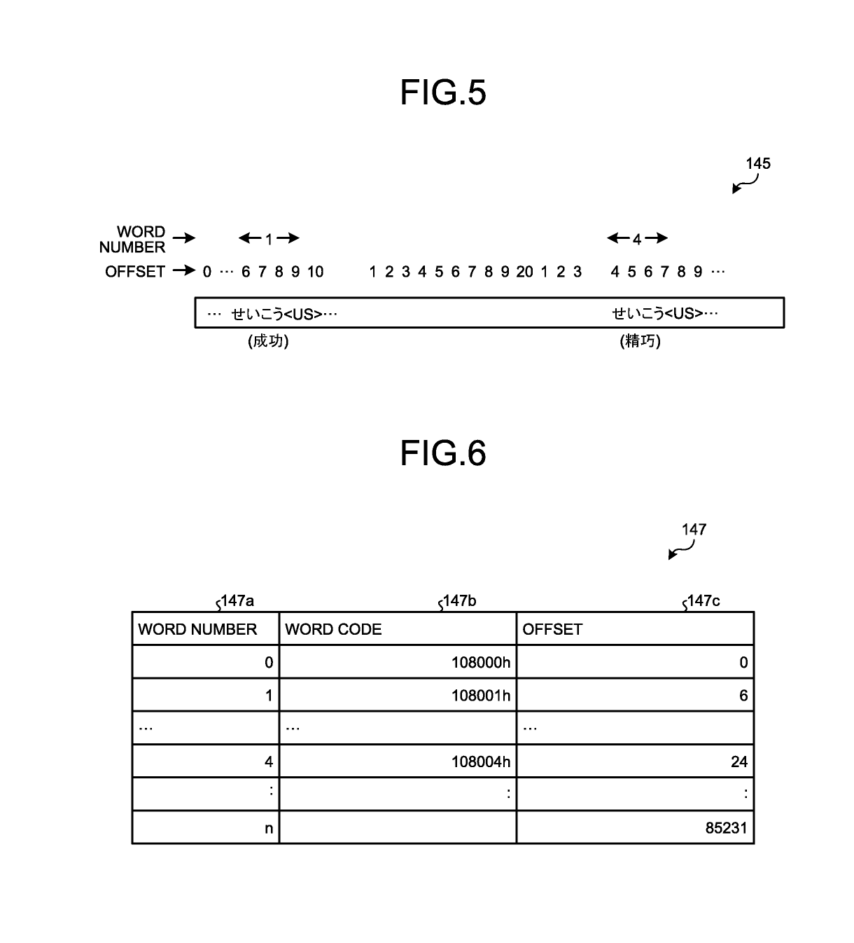

FIG. 5 is a schematic illustrating an exemplary data structure of the sequence data. As illustrated in FIG. 5, phonetic kana characters of each CJK word is separated by <US> in the sequence data 145. The numbers indicated above the sequence data 145 represent the offsets with respect to the head “0” of the sequence data 145. The numbers indicated above the offsets are word numbers that are sequentially assigned to the words in the sequence data 145, starting from the word at the head of the sequence data 145.

Referring back to FIG. 2, the index data 146 is a hash of the index 146′, as will be described later. The index 146′ is information mapping a character to an offset. An offset indicates the position of a character in the sequence data 145. For example, when a character “ [symbol] ” is found as the n₁^{th} character from the head in the sequence data 145, a flag “1” is set to the position of the offset n₁ in a row (bitmap) corresponding to the character “ [symbol] ” in the index 146′.

The index 146′ also maps the positions of the “head” and the “end” of a word, and the position of <US> to the offsets. For example, there is “ [symbol] ” at the head of the word “ [symbol] ”, and there is “ [symbol] ” at the end. When the character “ [symbol] ” that is at the head of the word “ [symbol] ” is the n₂^{th} character from the head in the sequence data 145, a flag “1” is set to the position of the offset n₂ in the row corresponding to the HEAD in the index 146′. When the character “ [symbol] ” at the end of the word “ [symbol] ” is the n₃^{th} character from the head in the sequence data 145, a flag “1” is set to the position of the offset n₃ in the row corresponding to the “END” in the index 146′. When “<US>” is the n₄^{th} character from the head in the sequence data 145, a flag “1” is set to the position of the offset n₄ in the row corresponding to “<US>” in the index 146′.

The index 146′ is hashed, in the manner described later, and is stored in the storage unit 140 as the index data 146. The index data 146 is generated by an index generating unit 152, which will be described later.

Referring back to FIG. 2, the offset table 147 is a table that stores therein the offset corresponding to the head of each word, based on the bitmap corresponding to the HEAD in the index data 146, the sequence data 145, and the dictionary data 142. The offset table 147 is generated, for example, when the index data 146 is unhashed.

FIG. 6 is a schematic illustrating an exemplary data structure of the offset table. As illustrated in FIG. 6, the offset table 147 stores therein a word number 147a, a word code 147b, and an offset 147c in a manner mapped to one another. The word number 147a is a number that is sequentially assigned to each of the words included in the sequence data 145, from the head of the sequence data 145. The word number 147a is a number assigned from “0” in an ascending order. The word code 147b corresponds to the word code 142c in the dictionary data 142. The offset 147c represents the position (offset) of the “head” of the word, with respect to the head of the sequence data 145. For example, if the word “ [symbol] ”, which corresponds to the word code “108001h”, is the first word from the head of the sequence data 145, “1” is set as a word number. If the character “ [symbol] ” that is at the head of the word “ [symbol] ” corresponding to the word code “108001h”, is the sixth character from the head of the sequence data 145, “6” is set as the offset.

Referring back to FIG. 2, the static dictionary data 148 is information that maps a word to a static code.

The dynamic dictionary data 149 is information for assigning a dynamic code to a word (or a character string) not defined in the static dictionary data 148.

Referring back to FIG. 2, the control unit 150 includes the sentence HMM generating unit 151, an index generating unit 152, a word candidate extracting unit 153, a sentence extracting unit 154, and a word presuming unit 155. The control unit 150 can be implemented using a central processing unit (CPU) or a micro-processing unit (MPU), for example. The control unit 150 may also be implemented using a hard wired logic such as an application-specific integrated circuit (ASIC) or a field-programmable gate array (FPGA).

The sentence HMM generating unit 151 generates the sentence HMM data 143 based on the dictionary data 142 and the training data 141.

For example, the sentence HMM generating unit 151 encodes each word included in the training data 141, based on the dictionary data 142. The sentence HMM generating unit 151 selects the words included in the training data 141 one after another. The sentence HMM generating unit 151 then identifies a sentence having some association with the selected word, from those included in the training data 141, and calculates a sentence vector of the identified sentence. The sentence HMM generating unit 151 calculates the co-occurring ratio of the selected word and the sentence vector of the identified sentence. The sentence HMM generating unit 151 then maps the sentence vector of the identified sentence and the co-occurring ratio to the word code of the selected word, and stores the mapping in the sentence HMM data 143. The sentence HMM generating unit 151 generates the sentence HMM data 143 by repeating the process while swapping the word to be selected.

The index generating unit 152 generates the index data 146 for each of the words included in the character string data 144, using the dictionary data 142.

For example, the index generating unit 152 compares the character string data 144 with the dictionary data 142. The index generating unit 152 scans the character string data 144 from the head, and extracts the phonetic kana characters of a character string matching with a CJK word 142b, among those registered in the dictionary data 142. The index generating unit 152 stores the phonetic kana characters of the matching character string in the sequence data 145. Before the index generating unit 152 stores the phonetic kana characters of a next matching character string in the sequence data 145, the index generating unit 152 sets <US> next to the previous character string, and stores the phonetic kana characters of the next matching character string, in a manner following the set <US>. The index generating unit 152 generates the sequence data 145 by operating the character string data 144 and repeating the process described above.

The index generating unit 152 generates the index 146′ after the sequence data 145 is generated. The index generating unit 152 generates the index 146′ by scanning the sequence data 145 from the head, and by mapping a CJK character to an offset, the head of the CJK character string to an offset, the end of the CJK character string to an offset, and <US> to an offset.

The index generating unit 152 also generates a high-level index of the heads of CJK character strings, by mapping the heads of CJK character strings to word numbers. By causing the index generating unit 152 to generate a high-level index corresponding to the granularity of the word numbers or the like in the manner described above, it is possible to speed up the process of narrowing down the range from which a keyword is extracted in the subsequent process.

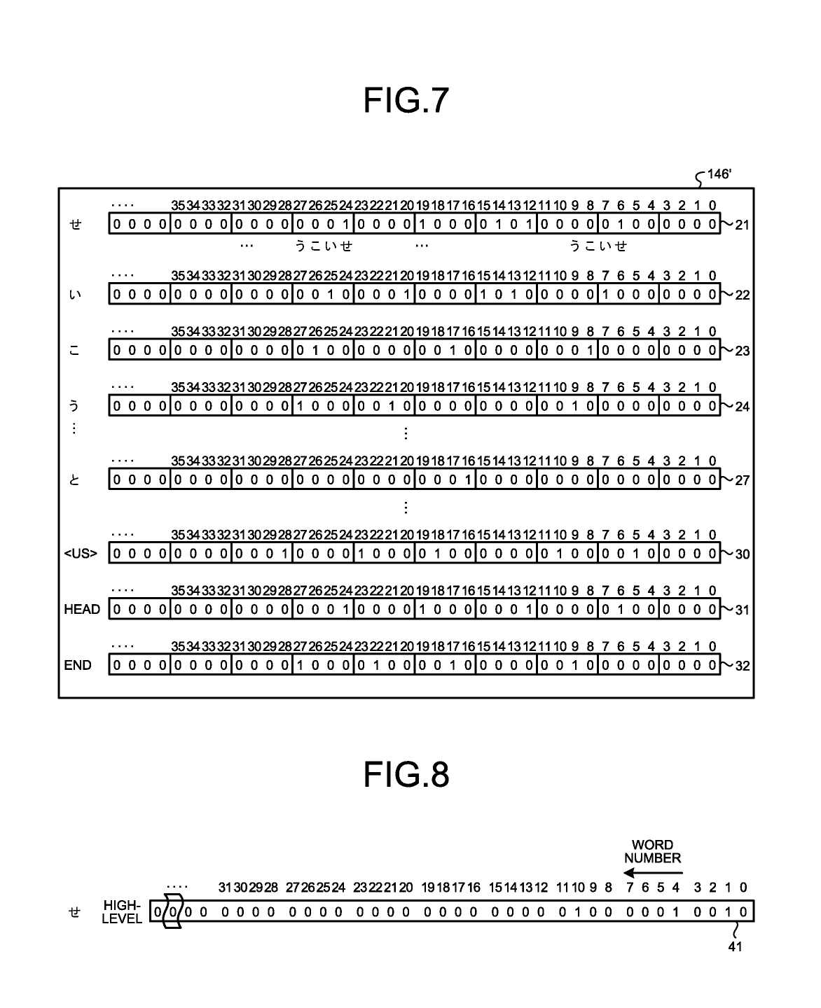

FIG. 7 is a schematic illustrating an exemplary data structure of the index. FIG. 8 is a schematic illustrating an exemplary data structure of the high-level index. As illustrated in FIG. 7, the index 146′ includes bitmaps 21 to 32 that correspond to CJK characters, <US>, the HEAD, and the END, respectively.

For example, it is assumed herein that the bitmaps 21 to 24 correspond to the respective CJK characters “ [symbol] ”, “ [symbol] ”, “ [symbol] ”, “ [symbol] ”, . . . included in the sequence data 145 “ . . . [symbol] <US> . . . [symbol] <US> . . . ” In FIG. 7, the bitmaps corresponding to the other CJK characters are not illustrated.

It is assumed that a bitmap 30 is the bitmap corresponding to <US>, that a bitmap 31 is the bitmap corresponding to the “HEAD” characters, and that a bitmap 32 is the bitmap corresponding to the “END” characters.

For example, in the sequence data 145 illustrated in FIG. 5, the CJK character “ [symbol] ” is found at the offsets “6, 24, . . . ” in the sequence data 145. Therefore, the index generating unit 152 sets a flag “1” to each of the offsets “6, 24, . . . ” in the bitmap 21 of the index 146′ illustrated in FIG. 7. In the same manner, the flags are set for the other CJK characters and <US> in the sequence data 145.

In the sequence data 145 illustrated in FIG. 5, the heads of the CJK words are found at offsets “6, 24, . . . ” in the sequence data 145. Therefore, the index generating unit 152 sets a flag “1” to the offsets “6, 24, . . . ” in the bitmap 31 of the index 146′ illustrated in FIG. 7.

In the sequence data 145 illustrated in FIG. 5, the ends of the CJK words are found at the offsets “9, 27, . . . ” in the sequence data 145. Therefore, the index generating unit 152 sets a flag “1” to the offsets “9, 27, . . . ” in the bitmap 32 of the index 146′ illustrated in FIG. 7.

As illustrated in FIG. 8, the index 146′ has a higher-level bitmap corresponding to the heads of the CJK character strings. It is assumed that a higher-level bitmap 41 is the higher-level bitmap corresponding to “ [symbol] ”. In the sequence data 145 illustrated in FIG. 5, the CJK words assigned with word numbers “1, 4” have “ [symbol] ” as the head character in the sequence data 145. Therefore, the index generating unit 152 sets a flag “1” to the word numbers “1, 4” in the higher-level bitmap 41 of the index 146′ illustrated in FIG. 8.

Once the index 146′ is generated, the index generating unit 152 generates the index data 146 by hashing the index 146′, to reduce the amount of data of the index 146′.

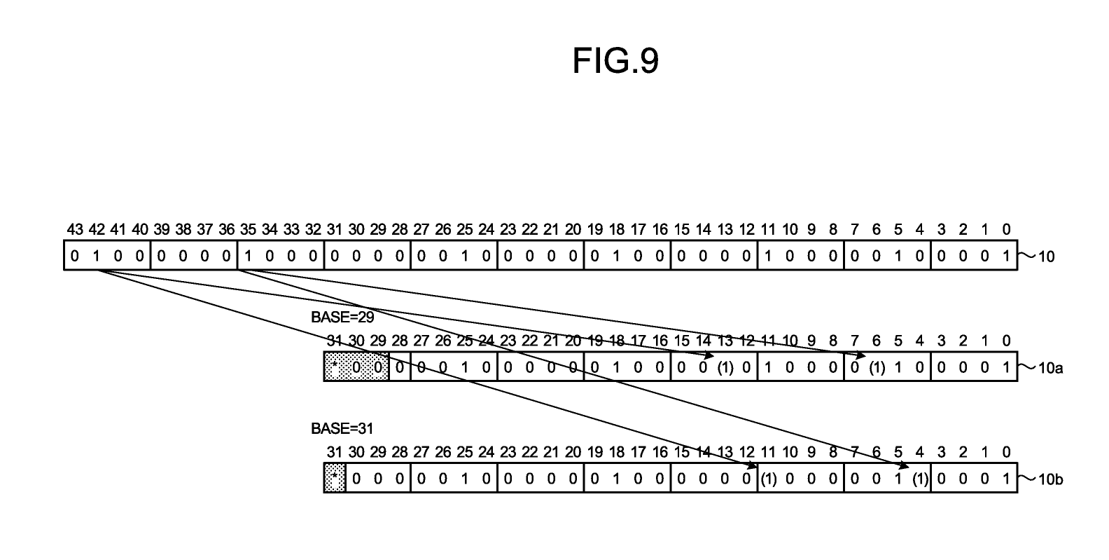

FIG. 9 is a schematic for explaining hashing of an index. In the explanation below, it is assumed, as an example, that the index includes a bitmap 10, and the bitmap 10 is hashed.

For example, the index generating unit 152 generates a bitmap 10a with base 29 and a bitmap 10b with base 31, from the bitmap 10. The index generating unit 152 sets delimiters in increments of 29 offsets in the bitmap 10, and represents the offset of each flag “1” set in the bitmap 10 as a flag set to an offset within the range of the offsets 0 to 28 in the bitmap 10a, with respect to corresponding one of the set delimiters as a head.

The index generating unit 152 copies the information at the offsets 0 to 28 in the bitmap 10 to those in the bitmap 10a. For the information at the offset 29 and thereafter in the bitmap 10a, the index generating unit 152 performs the process described below.

In the bitmap 10, a flag “1” is set to the offset “35”. Because the offset “35” is an offset “29+6”, the index generating unit 152 sets a flag “(1)” to the offset “6” in the bitmap 10a. The first offset is set to zero. In the bitmap 10, another flag “1” is set to the offset “42”. Because the offset “42” is an offset “29+13”, the index generating unit 152 sets a flag “(1)” to the offset “13” in the bitmap 10a.

For the bitmap 10b, the index generating unit 152 sets delimiters in increments of 31 offsets in the bitmap 10, and represents the offset of each flag “1” set in the bitmap 10 as a flag set to an offset within the range of offsets 0 to 30 in the bitmap 10b, with respect to corresponding one of the set delimiters as a head.

A flag “1” is set to the offset “35” in the bitmap 10. Because the offset “35” is an offset “31+4”, the index generating unit 152 sets a flag “(1)” to the offset “4” in the bitmap 10b. The first offset is set to 0. A flag “1” is set to the offset “42” in the bitmap 10. Because the offset “42” is an offset “31+11”, the index generating unit 152 sets a flag “(1)” to the offset “11” in the bitmap 10b.

The index generating unit 152 generates the bitmaps 10a, 10b from the bitmap 10 by executing the process described above. These bitmaps 10a, 10b are resultant of hashing the bitmap 10.

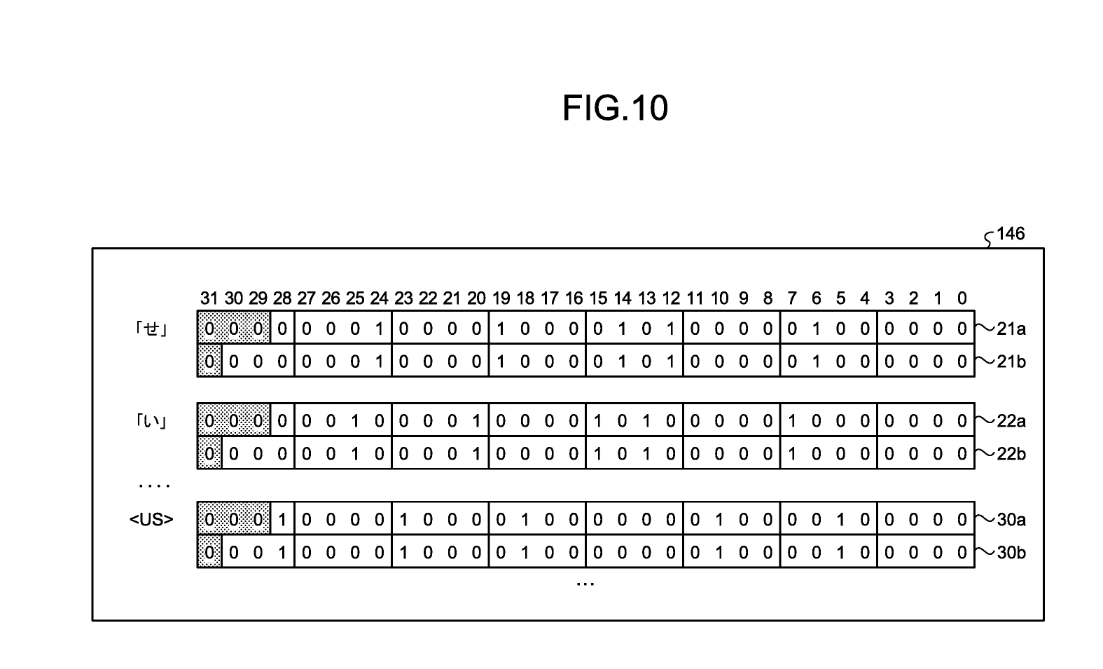

By hashing the bitmaps 21 to 32 illustrated in FIG. 7, the index generating unit 152 generates the hashed index data 146. FIG. 10 is a schematic illustrating an exemplary data structure of the index data. For example, a bitmap 21a and a bitmap 21b illustrated in FIG. 10 are generated by hashing the bitmap 21 yet to be hashed included in the index 146′ illustrated in FIG. 7. A bitmap 22a and a bitmap 22b illustrated in FIG. 10 are generated by hashing the bitmap 22 yet to be hashed in the index 146′ illustrated in FIG. 7. A bitmap 30a and a bitmap 30b illustrated in FIG. 10 are generated by hashing the bitmap 30 yet to be hashed in the index 146′ illustrated in FIG. 7. In FIG. 10, other bitmaps resultant of hashing are not illustrated.

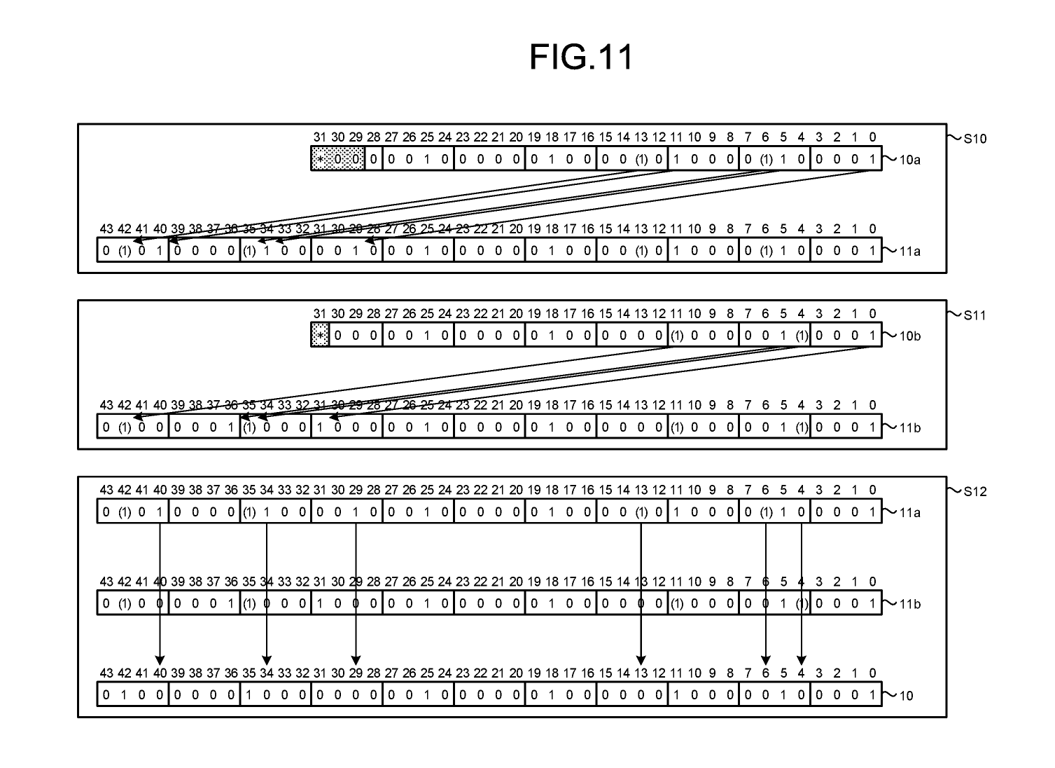

A process of unhashing a hashed bitmap will now be explained. FIG. 11 is a schematic for explaining an example of a process of unhashing a hashed index. In the example below, the process of unhashing the bitmap 10a and the bitmap 10b into the bitmap 10 will be explained, as an example. The bitmaps 10, 10a, 10b correspond to those explained with reference to FIG. 9.

The process at Step S10 will now be explained. In the unhashing process, a bitmap 11a is generated based on the bitmap 10a with base 29. The information of the flags set to the offsets 0 to 28 in the bitmap 11a is the same as the information of the flags set to the offset 0 to 28 in the bitmap 10a. The information of the flags set to the offset 29 and thereafter in the bitmap 11a is a repetition of the information of the flags set to the offset 0 to 28 in the bitmap 10a.

The process at Step S11 will now be explained. In the unhashing process, a bitmap 11b is generated based on the bitmap 10b with base 31. The information of the flags set to the offsets 0 to 30 in the bitmap 11b is the same as the information of the flags set to the offsets 0 to 30 in the bitmap 10b. The information of the flags set to the offsets 31 and thereafter in the bitmap 11b is a repetition of the information of the flags set to the offsets 0 to 30 in the bitmap 10b.

The process at Step S12 will now be explained. In the unhashing process, the bitmap 10 is generated by executing an AND operation of the bitmap 11a and the bitmap 11b. In the example illustrated in FIG. 11, the flags “1” are set to the offsets “0, 5, 11, 18, 25, 35, 42” in both of the bitmap 11a and the bitmap 11b. Therefore, the flag “1” is set to the offsets “0, 5, 11, 18, 25, 35, 42” in the bitmap 10. This bitmap 10 is the bitmap resultant of unhashing. In the unhashing process, by repeating the same process for the other bitmaps, the bitmaps are unhashed, and the index 146′ is generated.

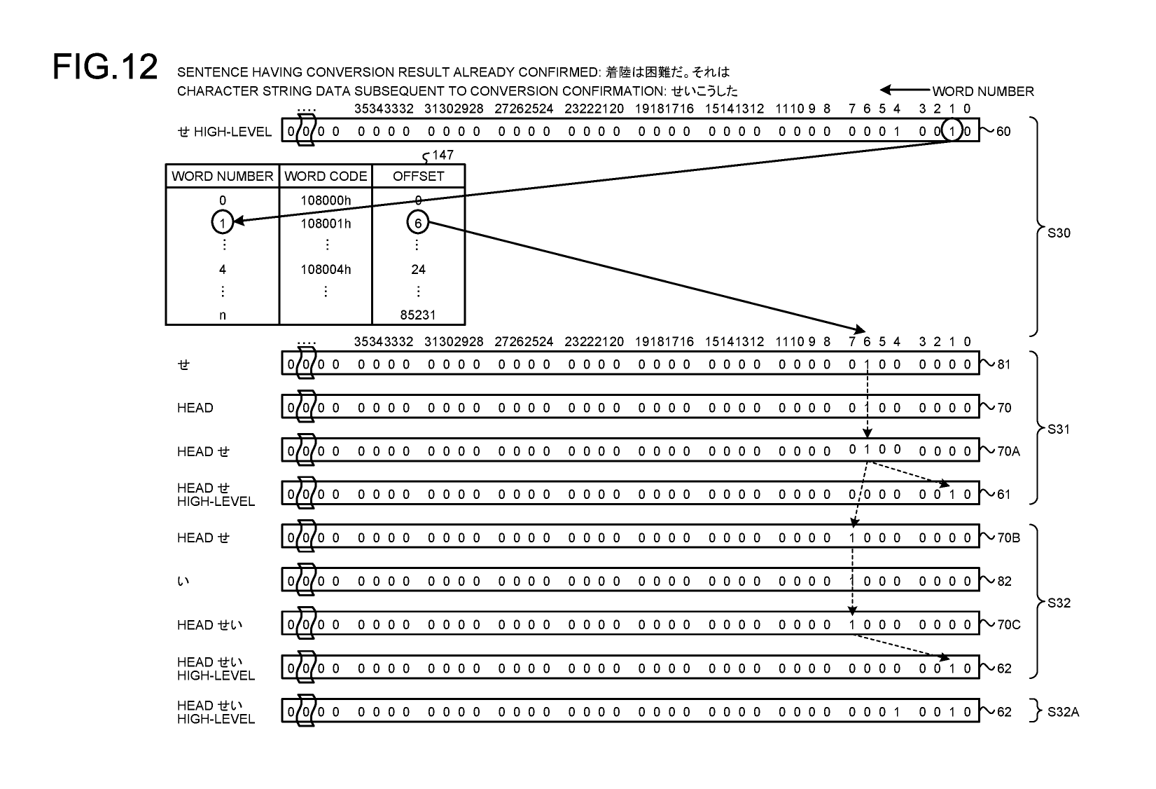

Referring back to FIG. 2, the word candidate extracting unit 153 is a processing unit that generates the index 146′ from the index data 146, and extracts word candidates based on the index 146′. FIG. 12 is a schematic for explaining an example of a process of extracting a word candidate. In the example illustrated in FIG. 12, it is assumed that an operation instructing a conversion of a new piece of character string data is received after an operation for confirming the conversion result of a character or a character string has been received. It is assumed herein that the new piece of character string data is a piece of character string data to be converted, and is “ [symbol] ”. The word candidate extracting unit 153 reads the higher-level bitmap and the lower-level bitmap corresponding to each of the characters included in the character string data to be converted, from the index data 146, sequentially from the first character in the character string data to be converted, and executes the following process.

To begin with, the word candidate extracting unit 153 reads the bitmap corresponding to the HEAD from the index data 146, and unhashes the read bitmap. The explanation of the unhashing process is omitted, because the process is explained above with reference to FIG. 11. The word candidate extracting unit 153 generates the offset table 147 using the unhashed bitmap corresponding to the HEAD, the sequence data 145, and the dictionary data 142. For example, the word candidate extracting unit 153 identifies the offset at which “1” is set, in the unhashed bitmap corresponding to the HEAD. If “1” is set to the offset “6”, for example, the word candidate extracting unit 153 refers to the sequence data 145 and identifies the CJK word at the offset “6” and the word number of the CJK word, and refers to the dictionary data 142 and extracts the word code of the identified CJK word. The word candidate extracting unit 153 then adds the word number, the word code, and the offset to the offset table 147, in a manner mapped to one another. The word candidate extracting unit 153 generates the offset table 147 by repeating the process described above.

Step S30 will now be explained. The word candidate extracting unit 153 reads the higher-level bitmap corresponding to “ [symbol] ” that is the first character of the character string data subsequent to the conversion confirmation from the index data 146, and establishes the result of unhashing the read higher-level bitmap as a higher-level bitmap 60. Because the unhashing process is explained above with reference to FIG. 11, the explanation thereof will be omitted. The word candidate extracting unit 153 then identifies the word number at which the flag “1” is set in the higher-level bitmap 60, and identifies the offset of the identified word number by referring to the offset table 147. The higher-level bitmap 60 indicates that the flag “1” is set to the word number “1”, and that the offset of the word number “1” is “6”.

Step S31 will now be explained. The word candidate extracting unit 153 reads the bitmap corresponding to “ [symbol] ”, which is the first character of the character string data, and the bitmap corresponding to the HEAD, from the index data 146. The word candidate extracting unit 153 unhashes a range near the offset “6” from the read bitmap corresponding to the character “ [symbol] ” and establishes the unhashed result as a bitmap 81. The word candidate extracting unit 153 also unhashes a range near the offset “6” from the read bitmap corresponding to the HEAD, and establishes the unhashed result as a bitmap 70. As an example, the word candidate extracting unit 153 only unhashes the range corresponding to the base including bits “0” to “29” in which the offset “6” is included.

The word candidate extracting unit 153 identifies the head position of the characters by performing an AND operation of the bitmap 81 corresponding to the character “ [symbol] ” and the bitmap 70 corresponding to the HEAD. The result of the AND operation of the bitmap 81 corresponding to the character “ [symbol] ” and the bitmap 70 corresponding to the HEAD is established as a bitmap 70A. In the bitmap 70A, a flag “1” is set at the offset “6”, indicating that the head of the CJK word is at the offset “6”.

The word candidate extracting unit 153 corrects a higher-level bitmap 61 corresponding to the HEAD and the character “ [symbol] ”. A flag “1” is set to the word number “1” in the higher-level bitmap 61, because the result of the AND operation of the bitmap 81 corresponding to the character “ [symbol] ” and the bitmap 70 corresponding to the HEAD is “1”.

Step S32 will now be explained. The word candidate extracting unit 153 generates a bitmap 70B by shifting the bitmap 70A corresponding to the HEAD by one bit to the left. The word candidate extracting unit 153 then reads the bitmap corresponding to “ [symbol] ” that is the second character of the character string data subsequent to the conversion confirmation, from the index data 146. The word candidate extracting unit 153 unhashes a range near the offset “6” from the read bitmap corresponding to the character “ [symbol] ”, and establishes the unhashed result as a bitmap 82.

The word candidate extracting unit 153 then determines whether “ [symbol] ” is found at the head of the word number “1”, by executing an AND operation of the bitmap 82 corresponding to the character “ [symbol] ” and the bitmap 70B corresponding to the HEAD. The result of the AND operation of the bitmap 82 corresponding to the character “ [symbol] ” and the bitmap 70B corresponding to the HEAD is established as a bitmap 70C. The bitmap 70C indicates that a flag “1” is set to the offset “7”, and that the character string “ [symbol] ” is found at the head of the word number “1”.

The word candidate extracting unit 153 corrects a higher-level bitmap 62 corresponding to the HEAD and the character string “ [symbol] ”. A flag “1” is set to the word number “1” in the higher-level bitmap 62, because the result of the AND operation of the bitmap 82 corresponding to the character “ [symbol] ” and the bitmap 70B corresponding to the HEAD is “1”. In other words, it can be seen that the character string data “ [symbol] ” subsequent to the conversion confirmation is at the head of the word with the word number “1”.

The word candidate extracting unit 153 then generates the higher-level bitmap 62 corresponding to the HEAD and the character string “ [symbol] ”, from the higher-level bitmap 60 corresponding to “ [symbol] ” that is the first character of the character string data, by repeating the process described above for the other word numbers at which a flag “1” is set (S32A). In other words, because the higher-level bitmap 62 is generated, it can be recognized which words include “ [symbol] ” at the head, among those including “ [symbol] ” in the character string data subsequent to the conversion confirmation. In other words, the word candidate extracting unit 153 extracts the words candidates in which “ [symbol] ” is found at the head, from those included in the character string data subsequent to the conversion confirmation. In FIG. 12, to extract a word candidate, the word candidate extracting unit 153 uses two characters “ [symbol] ” included in the character string data subsequent to the conversion confirmation, but the word candidate extracting unit 153 may also use three characters “ [symbol] ” or four characters “ [symbol] ”.

Referring back to FIG. 2, if the character string data subsequent to the conversion confirmation includes a character string corresponding to a plurality of words with different meanings, the sentence extracting unit 154 extracts characterizing sentence data having some association with the character string data subsequent to the conversion confirmation, from the sentences or texts having the conversion results already confirmed. For example, the sentence extracting unit 154 determines whether the character string data subsequent to the conversion confirmation includes any character string corresponding to a plurality of homonyms words. As an example, the sentence extracting unit 154 determines whether the word candidates extracted by the word candidate extracting unit 153 are homonyms, using the higher-level bitmap 62 corresponding to the character string data subsequent to the conversion confirmation, the offset table 147, and the dictionary data 142. If the word candidates extracted by the word candidate extracting unit 153 are homonyms, the sentence extracting unit 154 refers to the storage unit 140 storing therein the sentences or texts having the conversion results already confirmed, and extracts a sentence having the conversion result already confirmed before the operation for executing the conversion is received, as the characterizing sentence data.

The word presuming unit 155 presumes which words are to be used as the candidates of the kana-to-kanji conversion, from the word candidates extracted by the word candidate extracting unit 153, based on the characterizing sentence data and the sentence HMM data 143. For example, the word presuming unit 155 performs a process of calculating a sentence vector from the characterizing sentence data extracted by the sentence extracting unit 154, and then presumes the words based on the calculated sentence vector and the sentence HMM data 143.

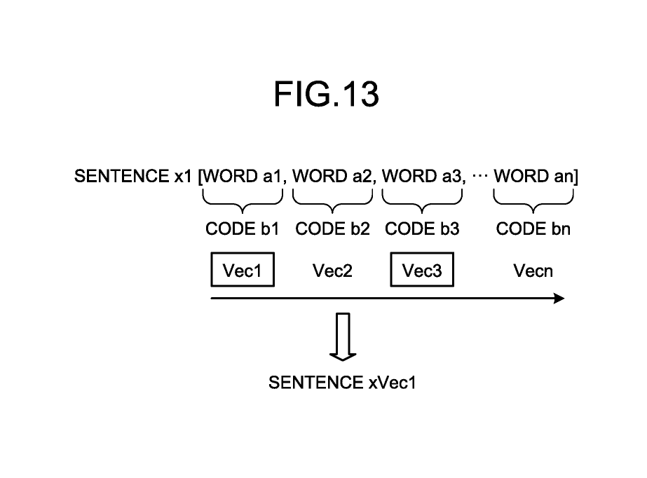

An example of the process in which the word presuming unit 155 calculates a sentence vector will now be explained with reference to FIG. 13. FIG. 13 is a schematic for explaining an example of the process of calculating a sentence vector. In FIG. 13, a process of calculating the vector xVec1 of a sentence x1 will be explained, as an example.

For example, a sentence x1 includes words al to an. The word presuming unit 155 encodes each of these words included in the sentence x1, using the static dictionary data 148 and the dynamic dictionary data 149.

As an example, if there is a match with a word in the static dictionary data 148, the word presuming unit 155 encodes the word by identifying the static code of the word, and replacing the word with the identified static code. If there is no match with any word in the static dictionary data 148, the word presuming unit 155 identifies a dynamic code, using the dynamic dictionary data 149. For example, if the word is not registered in the dynamic dictionary data 149, the word presuming unit 155 registers the word to the dynamic dictionary data 149, and acquires the dynamic code corresponding to the registered position. If the word is registered in the dynamic dictionary data 149, the word presuming unit 155 acquires the dynamic code corresponding to the registered position where the word is already registered. The word presuming unit 155 encodes the word by replacing the word with the identified dynamic code.

In the example illustrated in FIG. 13, the word presuming unit 155 encodes the words al to an by replacing these words with codes b1 to bn, respectively.

After encoding each of the words, the word presuming unit 155 then calculates a word vector of each of the words (each of the codes) based on the Word2Vec technology. Word2Vec technology performs a process of calculating a vector of each code, based on a relation between a word (code) and another word (code) adjacent thereto. In the example illustrated in FIG. 13, the word presuming unit 155 calculates word vectors Vecl to Vecn for the codes b1 to bn, respectively. The word presuming unit 155 then calculates a sentence vector xVec1 of the sentence x1 by integrating the word vectors Vecl to Vecn.

Referring back to FIG. 2, explained now is an example of a process in which the word presuming unit 155 determines the order in which the word candidates extracted by the word candidate extracting unit 153 are displayed, based on the calculated sentence vector and the sentence HMM data 143. The word presuming unit 155 refers to the sentence HMM data 143, and determines the order in which word candidates extracted by the word candidate extracting unit 153 are displayed based on the co-occurring sentence vector 143b having some association with the calculated sentence vector, among the co-occurring sentence vectors 143b.

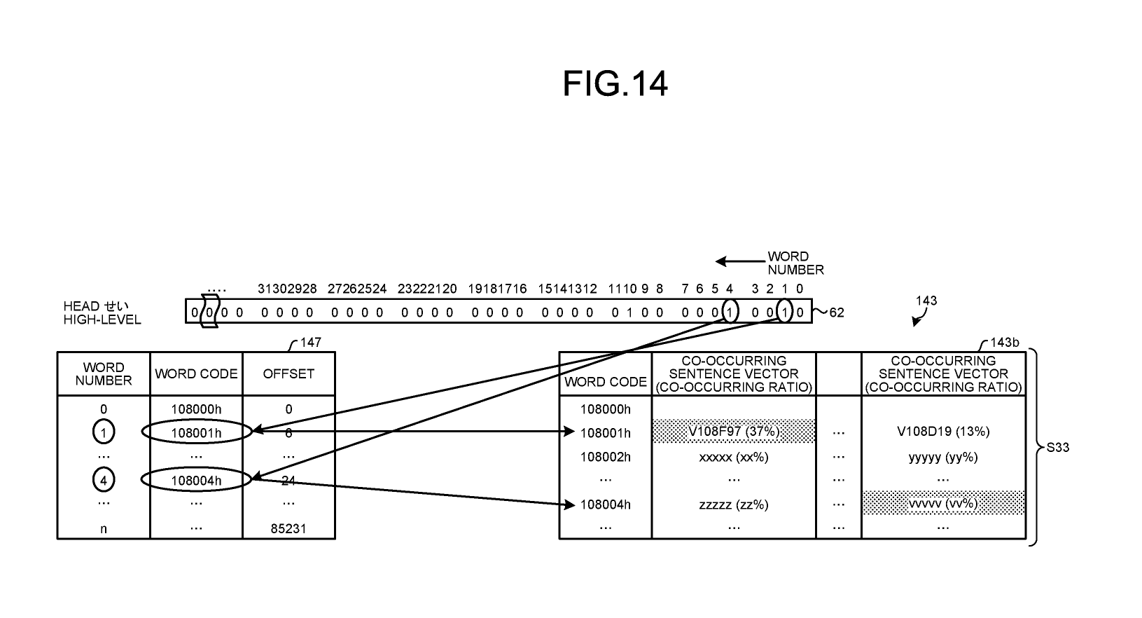

FIG. 14 is a schematic for explaining an example of a process of presuming a word. In the example illustrated in FIG. 14, it is assumed that the word candidate extracting unit 153 has generated the higher-level bitmap 62 corresponding to the HEAD and the character string “ [symbol] ”, as explained to be performed at S32A in FIG. 12.

Step S33 illustrated in FIG. 14 will now be explained. The sentence extracting unit 154 identifies the word numbers set with “1” in the higher-level bitmap 62 corresponding to the HEAD and the character string “ [symbol] ”. In this example, a flag “1” is set to the word number “1” and the word number “4”, and therefore, the word number “1” and the word number “4” are identified. The sentence extracting unit 154 then acquires the word codes corresponding to the identified word numbers from the offset table 147. In this example, “108001h” is acquired as the word code corresponding to the word number “1”, and “108004h” is acquired as the word code corresponding to the word number “4”. The sentence extracting unit 154 then identifies the words corresponding to the acquired word codes from the dictionary data 142. In this example, the sentence extracting unit 154 identifies “ [symbol] ” as a word corresponding to the word code “108001h”, and identifies “ [symbol] ” as the word corresponding to the word code “108004h”. These identified words serve as the word candidates.

In addition, because the identified word candidates have the same phonetic kana characters and different meanings, the sentence extracting unit 154 determines that these word candidates are homonyms. The sentence extracting unit 154 refers to the storage unit 140 storing therein the sentences or texts having the conversion results already confirmed, and extracts “ [symbol] ” that is a sentence having the conversion result already confirmed before the operation for executing the conversion is received.

The word presuming unit 155 then compares the sentence vector of the extracted sentence with each of the co-occurring sentence vectors corresponding to the acquired word codes in the sentence HMM data 143, and identifies the co-occurring sentence vector 143b matching or similar to the sentence vector. In this example, it is assumed that the word presuming unit 155 identifies the co-occurring sentence vectors 143b in the highlighted portions of the sentence HMM data 143.

The word presuming unit 155 then calculates the score for each permutation of the co-occurrent words using the co-occurring ratios of the identified co-occurring sentence vectors. For example, the word presuming unit 155 acquires, for each of the acquired word codes, the co-occurring ratio of the identified co-occurring sentence vector 143b. The word presuming unit 155 then calculates the score of each of the permutations of the word codes, using the co-occurring ratios acquired for each of the word codes.

The word presuming unit 155 determines the order in the permutation with the higher score as the order in which the word codes are displayed. The word presuming unit 155 then outputs the words specified by the respective word codes in the determined order for displaying, as the kana-to-kanji conversion candidates, in a selectable manner. In other words, the word presuming unit 155 presumes kana-to-kanji conversion candidates for a character or a character string for which an operation for conversion is received subsequently to the confirmation of a conversion, determines the order for displaying the presumed kana-to-kanji conversion candidates, and displays the conversion candidates in the determined order for displaying.

As an example, it is assumed that the sentence vector of a sentence having some association with the character or the character string for which the operation instructing a conversion has been received matches or similar to the co-occurring sentence vector 143b “V0108F97”, and matches or similar to the co-occurring sentence vector 143b “vvvvv”. The word presuming unit 155 then calculates a higher score for a permutation “ [symbol] ” and “ [symbol] ”, than that calculated for a permutation “ [symbol] ” and “ [symbol] ”, using the co-occurring ratios of these co-occurring sentence vectors 143b. The word presuming unit 155 therefore determines the order “ [symbol] ” and “ [symbol] ” in the permutation resulted in a higher score as the order in which these words are displayed.

In the manner described above, because the word presuming unit 155 calculates the scores for the kana-to-kanji conversion from the sentence HMM by using the sentence vector of a sentence having some association with the character string data subsequent to the conversion confirmation, it is possible to improve the accuracy of the order in which the conversion candidates are displayed.

An example of the sequence of a process performed by the information processing apparatus 100 according to the embodiment will now be explained.

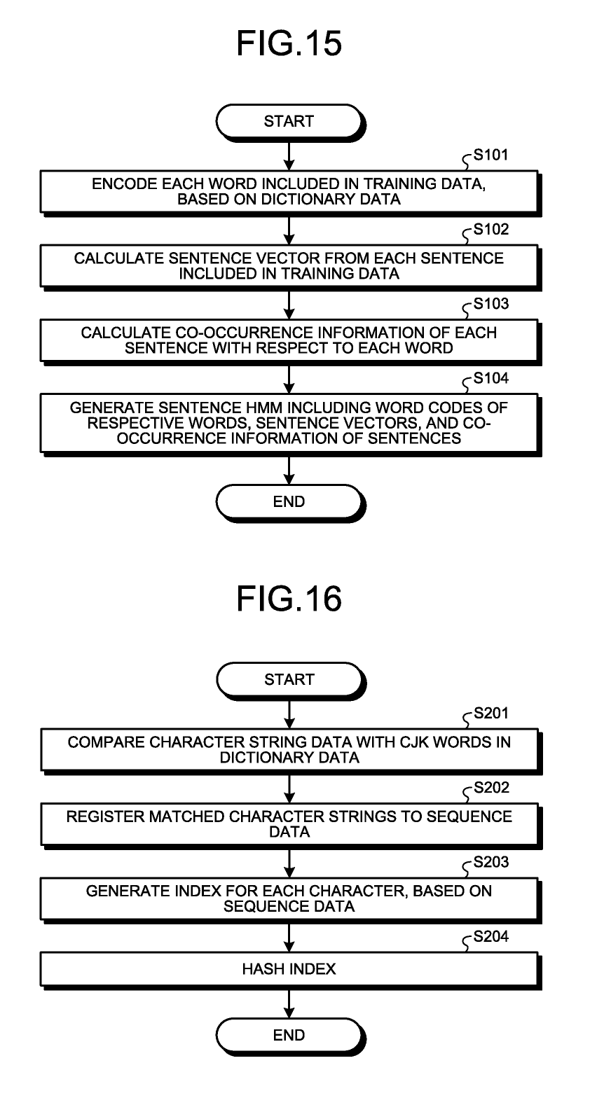

FIG. 15 is a flowchart illustrating the sequence of a process performed by the sentence HMM generating unit. As illustrated in FIG. 15, if the dictionary data 142 and the training data 141 to be used in the morphological analyses are received, the sentence HMM generating unit 151 in the information processing apparatus 100 encodes each word included in the training data 141, based on the dictionary data 142 (Step S101).

The sentence HMM generating unit 151 then calculates a sentence vector of each of the sentences included in the training data 141 (Step S102).

The sentence HMM generating unit 151 then calculates the co-occurrence information of each of the sentences with respect to each of the words included in the training data 141 (Step S103).

The sentence HMM generating unit 151 then generates the sentence HMM data 143 including the word codes of the respective words, the sentence vectors, and the co-occurrence information of the sentences (Step S104). In other words, the sentence HMM generating unit 151 stores the co-occurrence vector and the co-occurring ratio of a sentence in a manner mapped to the word code of a word, in the sentence HMM data 143.

FIG. 16 is a flowchart illustrating the sequence of a process performed by the index generating unit. As illustrated in FIG. 16, the index generating unit 152 in the information processing apparatus 100 compares the character string data 144 with the CJK words in the dictionary data 142 (Step S201).

The index generating unit 152 registers the matched character strings (CJK words) to the sequence data 145 (Step S202). The index generating unit 152 generates the index 146′ for each of the characters (CJK characters), based on the sequence data 145 (Step S203). The index generating unit 152 then generates the index data 146 by hashing the index 146′ (Step S204).

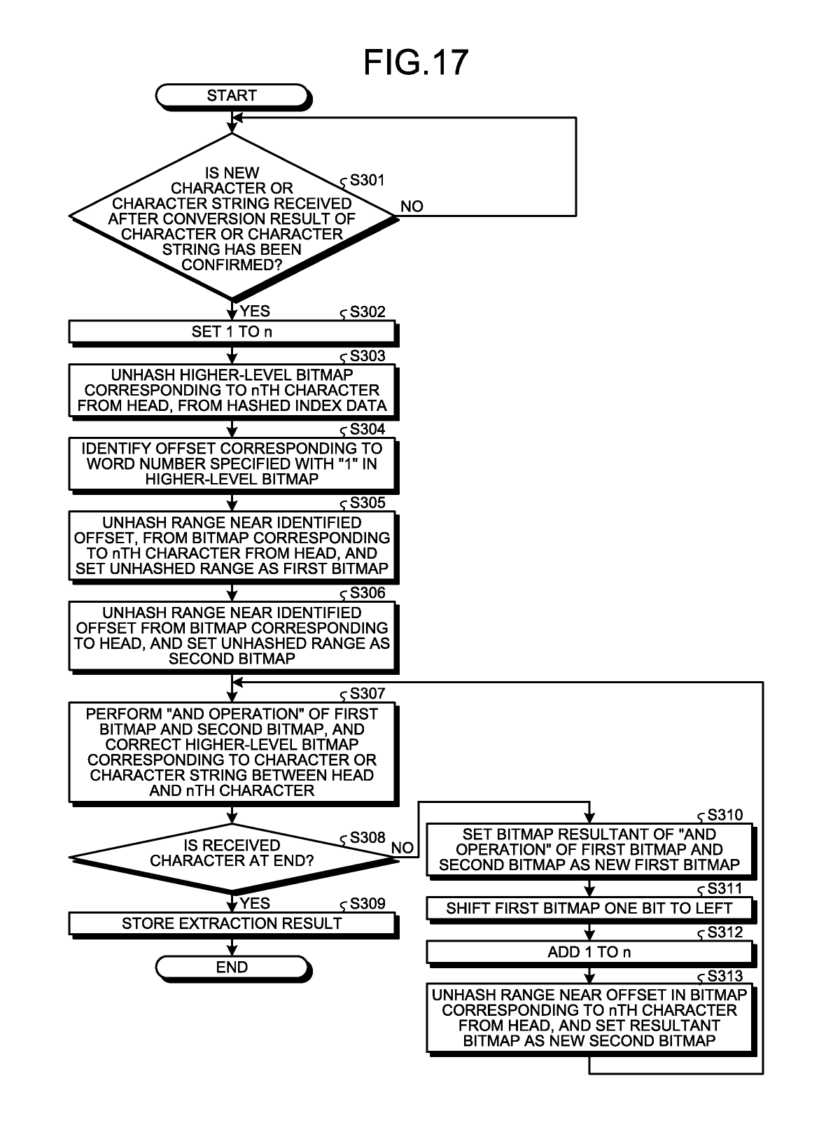

FIG. 17 is a flowchart illustrating the sequence of a process performed by the word candidate extracting unit. As illustrated in FIG. 17, the word candidate extracting unit 153 in the information processing apparatus 100 determines whether a new character or character string has been received after the conversion result of a character or a character string has been confirmed (Step S301). If the word candidate extracting unit 153 determines that no new character or character string has been received (No at Step S301), the word candidate extracting unit 153 repeats this determining process until a new character or character string is received.

If the word candidate extracting unit 153 determines that a new character or character string has been received (Yes at Step S301), the word candidate extracting unit 153 sets “1” to a temporary area “n” (Step S302). The word candidate extracting unit 153 unhashes the higher-level bitmap corresponding to the n^{th} character from the head, from the hashed index data 146 (Step S303).

The word candidate extracting unit 153 identifies the offset corresponding to a word number where “1” is set in the higher-level bitmap, by referring to the offset table 147 (Step S304). The word candidate extracting unit 153 then unhashes a range near the identified offset, from the bitmap corresponding to the n^{th} character from the head, and sets the unhashed range as a first bitmap (Step S305). The word candidate extracting unit 153 also unhashes a range near the identified offset from the bitmap corresponding to the HEAD, and sets the unhashed range as a second bitmap (Step S306).

The word candidate extracting unit 153 then performs an “AND operation” of the first bitmap and the second bitmap, and corrects the higher-level bitmap corresponding to the characters between the head and the n^{th} character or character string (Step S307). For example, if the result of AND is “0”, the word candidate extracting unit 153 corrects the higher-level bitmap by setting a flag “0” to the position corresponding to the word number in the higher-level bitmap corresponding to the characters between the head and the n^{th} character.

The word candidate extracting unit 153 then determines whether the received character is at the end (Step S308). If it is determined that the received character is at the end (Yes at Step S308), the word candidate extracting unit 153 stores the extraction result in the storage unit 140 (Step S309). The word candidate extracting unit 153 then ends the word candidate extracting process. If it is determined that received characters is not at the end (No at Step S308), the word candidate extracting unit 153 sets the bitmap resultant of the “AND operation” of the first bitmap and the second bitmap as a new first bitmap (Step S310).

The word candidate extracting unit 153 then shifts the first bitmap one bit to the left (Step S311). The word candidate extracting unit 153 then adds “1” to the temporary area n (Step S312). The word candidate extracting unit 153 then unhashes a range near the offset in the bitmap corresponding to the n^{th} character from the head, and sets the resultant bitmap as a new second bitmap (Step S313). The word candidate extracting unit 153 then shifts the process to Step S307 to perform the AND operation of the first bitmap and the second bitmap.

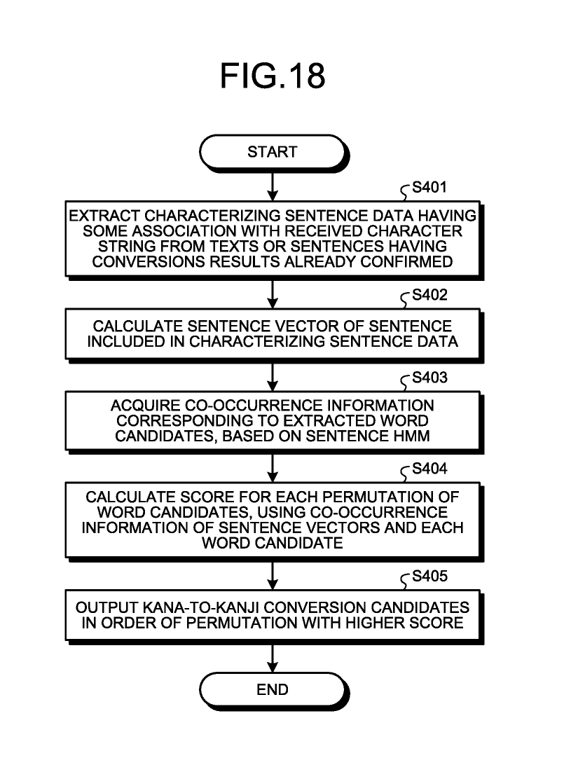

FIG. 18 is a flowchart illustrating the sequence of a process performed by the word presuming unit. In the explanation herein, it is assumed that the higher-level bitmap corresponding to the characters between the head and the n^{th} character of a character string that is newly received subsequently to the confirmation of a conversion has been stored as the extraction result extracted by the word candidate extracting unit 153.

To begin with, let us assume herein that the sentence extracting unit 154 in the information processing apparatus 100 determines that the word candidates are homonyms, using a higher-level bitmap corresponding to the character string newly subsequent to the conversion confirmation.

The sentence extracting unit 154 in the information processing apparatus 100 then extracts a piece of characterizing sentence data having some association with the newly received character string from the texts or the sentences having the conversion results already confirmed (Step S401). For example, the sentence extracting unit 154 refers to the storage unit 140 storing therein the sentences or texts having the conversion results already confirmed, and extracts the sentence immediately previous to the newly received character string as the characterizing sentence data.

The sentence extracting unit 154 then calculates a sentence vector of the sentence included in the characterizing sentence data (Step S402). The sentence vector is calculated in the manner as explained with reference to FIG. 13.

The word presuming unit 155 in the information processing apparatus 100 then acquires the co-occurrence information corresponding to the extracted word candidates, based on the sentence HMM data 143 (Step S403). For example, the word presuming unit 155 identifies the word numbers where “1” is specified in the higher-level bitmap corresponding to the newly received character string, and acquires the word code corresponding to each of the identified word numbers from the offset table 147. The word presuming unit 155 then acquires the co-occurring sentence vectors and the co-occurring ratios corresponding to the acquired word codes.

The word presuming unit 155 then calculates the score for each permutation of the word candidates, using the co-occurrence information of the sentence vectors and the word candidates (Step S404). For example, the word presuming unit 155 compares the calculated sentence vector with the co-occurring sentence vector corresponding to each of the acquired word codes in the sentence HMM data 143, and identifies the co-occurring sentence vector matching or similar to the sentence vector. The word presuming unit 155 acquires the co-occurring ratio of the identified co-occurring sentence vector for each of the acquired word codes. The word presuming unit 155 calculates a score for each permutation of the acquired word codes, using the co-occurring ratio acquired for each of the word codes.

The word presuming unit 155 outputs the kana-to-kanji conversion candidates in the order in the permutation with the higher score (Step S405). For example, the word presuming unit 155 displays the CJK words represented by the word codes corresponding to the permutation on the display unit 130 in the order in the permutation resulted in the higher score, as the kana-to-kanji conversion candidates, in a selectable manner.

In the embodiment, if the character string data subsequent to the conversion confirmation includes a character string corresponding to a plurality of words with different meanings, the sentence extracting unit 154 extracts a sentence having some association with the character string data subsequent to the conversion confirmation, from the sentences or texts having the conversion results already confirmed, as the characterizing sentence data. The word presuming unit 155 then determines the order in which the word candidates extracted by the word candidate extracting unit 153 are displayed, based on the sentence vector of the characterizing sentence data and the sentence HMM data 143. Alternatively, the sentence extracting unit 154 may extract, instead of the sentence data, text data including a plurality of pieces of sentence data. In such a configuration, the sentence extracting unit 154 extracts text data having some association with the character string data subsequent to the conversion confirmation, as characterizing text data. The word presuming unit 155 can then presume the order in which the word candidates extracted by the word candidate extracting unit 153 are displayed, based on the text vector of the characterizing text data and a text HMM data 143′. The text HMM data 143′ may map a word to a plurality of co-occurrence text vectors.

### Advantageous Effects Achieved by Embodiment

Advantageous effects achieved by the information processing apparatus 100 according to the embodiment will now be explained. When an operation for converting a piece of text data is received, the information processing apparatus 100 determines whether the piece of text data includes any word text corresponding to a plurality of words with different meanings. If such a word text is included, the information processing apparatus 100 acquires a confirmed text having a conversion result already confirmed before the operation is received, by referring to a first storage unit that stores therein confirmed texts having their conversion results already confirmed, refers to the sentence HMM data 143 that stores therein pieces of co-occurrence information of texts with respect to each of the words in a manner mapped to the word, and determines the order in which a plurality of words are displayed based on the co-occurrence information having some association with the acquired confirmed text, among the pieces of co-occurrence information of the texts. The information processing apparatus 100 displays a plurality of words in the determined order for displaying, in a selectable manner as the conversion candidates. With such a configuration, the information processing apparatus 100 determines the order in which words that are conversion candidates are displayed based on the co-occurrence with a confirmed text having its conversion result already confirmed. Therefore, it is possible to improve the accuracy of the order in which the words that are the conversion candidates are displayed. As a result, the information processing apparatus 100 can display the words that are the conversion candidates in the order that is determined based on the likeliness of such words being selected.

Furthermore, the information processing apparatus 100 determines the order in which the words are based on the co-occurrence information of a text that is similar to the acquired confirmed text, among the pieces of co-occurrence information of the texts with respect to each of the words that correspond to the word text, by referring to the sentence HMM data 143. With such a configuration, the information processing apparatus 100 determines the order in which the words that are the conversion candidates are displayed, based on the co-occurrence of the confirmed text with respect to a text that is similar to the confirmed text. Therefore, the accuracy of the order in which the words that are the conversion candidates are displayed can be improved.

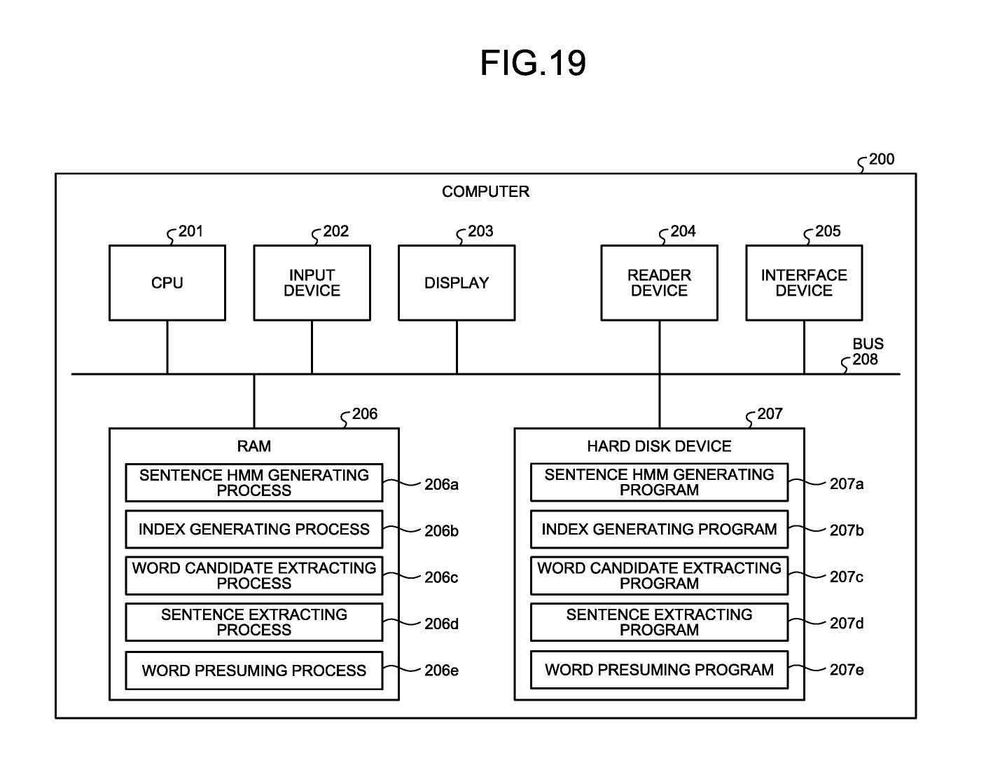

An exemplary hardware configuration of a computer implementing the same functions as those of the information processing apparatus 100 according to the embodiment will now be explained. FIG. 19 is a schematic illustrating an exemplary hardware configuration of a computer implementing the same functions as those of the information processing apparatus.

As illustrated in FIG. 19, this computer 200 includes a CPU 201 that executes various operations, an input device 202 that receives data inputs from a user, and a display 203. The computer 200 also includes a reader device 204 that reads a computer program or the like from a storage medium, and an interface device 205 that transmits and receives data to and from another computer over a wired or wireless network. The computer 200 also includes a random access memory (RAM) 206 that temporarily stores therein various types of information, and a hard disk device 207. Each of these devices 201 to 207 are connected to a bus 208.

The hard disk device 207 includes a sentence HMM generating program 207a, an index generating program 207b, a word candidate extracting program 207c, a sentence extracting program 207d, and a word presuming program 207e. The CPU 201 reads the sentence HMM generating program 207a, the index generating program 207b, the word candidate extracting program 207c, the sentence extracting program 207d, and the word presuming program 207e, and loads these computer programs onto the RAM 206.

The sentence HMM generating program 207a functions as a sentence HMM generating process 206a. The index generating program 207b functions as an index generating process 206b. The word candidate extracting program 207c functions as a word candidate extracting process 206c. The sentence extracting program 207d functions as a sentence extracting process 206d. The word presuming program 207e functions as a word presuming process 206e.

The sentence HMM generating process 206a corresponds to the process performed by the sentence HMM generating unit 151. The index generating process 206b corresponds to the process performed by the index generating unit 152. The word candidate extracting process 206c corresponds to the process performed by the word candidate extracting unit 153. The sentence extracting process 206d corresponds to the process performed by the sentence extracting unit 154. The word presuming process 206e corresponds to the process performed by the word presuming unit 155.

These computer programs 207a, 207b, 207c, 207d, 207e do not necessarily need to be stored in the hard disk device 207 from the beginning. For example, these computer programs may be stored in a “portable physical medium” such as a flexible disk (FD), a compact disc read-only memory (CD-ROM), a digital versatile (DVD) disc, and a magneto-optical disc, or an integrated circuit (IC) card that is inserted into the computer 200. The computer 200 may then be configured to read and to execute the computer programs 207a, 207b, 207c, 207d, 207e.

According to one aspect, it is possible to improve the accuracy of the order in which the conversion candidates are displayed.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein a display control program that causes a computer to execute a process comprising:
determining, when an operation for converting a piece of text data is received, whether the piece of text data includes a word text corresponding to a plurality of words with different meanings;
acquiring, when the word text is included, a confirmed text already having a conversion result confirmed before the operation is received, by referring to a first storage that stores therein confirmed texts already having conversion results confirmed, referring to a second storage that stores therein pieces of co-occurrence information of texts with respect to each of the words in a manner mapped to the word, and determining an order in which the words are displayed based on a piece of co-occurrence information of a text having some association with the acquired confirmed text, among the pieces of co-occurrence information of the texts; and
displaying the words in the determined order for displaying, in a selectable manner as conversion candidates.

2. The non-transitory computer-readable recording medium according to claim 1, wherein, at the determining, the order in which the words are displayed is determined based on a piece co-occurrence information of a text that is similar to the acquired confirmed text, among the pieces of co-occurrence information of the texts with respect to each of the words corresponding to the word text, by referring to the second storage.

3. The non-transitory computer-readable recording medium according to claim 1, wherein the pieces of co-occurrence information of the texts are information including vector information determined based on the texts.

4. A display control apparatus comprising:
a processor configured to:
determine, when an operation for converting a piece of text data is received, whether the piece of text data includes a word text corresponding to a plurality of words with different meanings;
acquire, when determining that the word text is included, a confirmed text already having a conversion result confirmed before the operation is received, by referring to a first storage storing therein confirmed texts already having conversion results confirmed, refer to a second storage storing therein pieces of co-occurrence information of texts with respect to each of the words in a manner mapped to the word, and determine an order in which the words are displayed based on a piece of co-occurrence information of a text having some association with the acquired confirmed text, among the pieces of co-occurrence information of the texts; and
display the words in the determined order for displaying, in a selectable manner as conversion candidates.

5. A display control method comprising:
determining, when an operation for converting a piece of text data is received, whether the piece of text data includes a word text corresponding to a plurality of words with different meanings;
acquiring, when the word text is included, a confirmed text already having a conversion result confirmed before the operation is received, by referring to a first storage that stores therein confirmed texts already having conversion results confirmed, referring to a second storage that stores therein pieces of co-occurrence information of texts with respect to each of the words in a manner mapped to the word, and determining an order in which the words are displayed based on a piece of co-occurrence information of a text having some association with the acquired confirmed text, among the pieces of co-occurrence information of the texts, by a processor; and
displaying the words in the determined order for displaying, in a selectable manner as conversion candidates.
